(19) United States
(12) Patent Application Publication
(10) Pub. No.: US 2016/0145493 A1
(43) Pub. Date: May 26, 2016

(54) DICHROIC-DYE-DOPED ISOTROPIC CHIRAL LIQUID CRYSTALS

(71) Applicant: EAST CHINA UNIVERSITY OF SCIENCE AND TECHNOLOGY, Shanghai (CN)

(72) Inventors: Zhigang ZHENG, Shanghai (CN); Chao WANG, Shanghai (CN)

(21) Appl. No.: 14/898,315

(22) PCT Filed: Jun. 14, 2013
(86) PCT No.: PCT/CN2013/077271

§ 371 Date: Dec. 14, 2015

(51) Int. Cl. C09K 19/60; C09K 19/54; C09K 19/58

(52) U.S. Cl. CPC C09K 19/601; C09K 19/586; C09K 19/542; C09K 19/544

(57) ABSTRACT

Disclosed are polarization-independent electro-optical compositions using dichroic-dye-doped polymer stabilized optically isotropic chiral liquid crystals. The isotropic phase of such compositions can be well maintained even if the temperature is below 0° C. The electro-optical performances of such compositions demonstrate large Kerr constants, fast response times, and large contrast ratios of the compositions. The power consumption and the cost of devices based on the compositions can be decreased substantially due to alignment-free and polarizer-free characteristics. The compositions can be used to generate low power consumption displays and other photonic devices.

### BACKGROUND

Optically isotropic chiral liquid crystals (OICLCs) have desirable properties of polarization-independence, being alignment free, and having fast response times. Polymer stabilization techniques may be used to expand the isotropic temperature range of such compositions. However, optical displays made with OICLCs require a polarizer due to in-plane electric-field induced anisotropy.

### SUMMARY

Liquid crystal compositions including a dichroic dye compound are disclosed. The liquid crystal compositions may include at least one nematic liquid crystal compound and at least one chiral agent in a polymer matrix, wherein the composition exhibits an optically isotropic liquid crystal phase. Liquid crystal compositions made with dichroic dye compounds are polarization-independent and have fast response times.

Methods of preparing a liquid crystal composition include combining at least one dichroic dye, at least one chiral agent, at least one nematic liquid crystal compound, and at least one monomer to give a mixture; heating the mixture to give an isotropic phase; and then polymerizing the mixture in the isotropic phase.

Disclosed are devices having at least one electrode disposed between a pair of substrates, a liquid crystal composition disposed between the pair of substrates, and an electric field application means for applying an electric field to the liquid crystal composition via the electrodes, wherein the liquid crystal composition comprises at least one dichroic dye compound. The liquid crystal composition may further include at least one nematic liquid crystal compound, at least one chiral agent in a polymer matrix, wherein the liquid crystal composition exhibits an optically isotropic liquid crystal phase.

### DESCRIPTION OF DRAWINGS

For a fuller understanding of the nature and advantages of the present technologies, reference should be had to the following detailed description taken in connection with the accompanying drawings, in which:

FIG. 1: Depicts a voltage modulated transmission spectrum of a homogenous aligned cell. The upper line is the transmission spectrum at a voltage of V_{S}. The lower line is the transmission spectrum in the absence of applied voltage (0 V). The x-axis is wavelength in nm, and the y-axis is percent transmittance.

FIG. 2: Depicts UV absorption behavior of dichroic-dye (2) during UV exposure for 0 minutes, 10 minutes, 25 minutes, and 40 minutes. The absorbance at 452 nanometers increases with time, while the absorbance at 365 nanometers decreases with time. The x-axis is wavelength in nm, and the y-axis is absorbance in a.u.

FIG. 3: Depicts voltage dependent contrast ratio behaviors as the polarization direction is changed from 0° (triangles), to 45° (circles), to 90° (squares). The x-axis is applied voltage (Vᵣₘₛ), and the y-axis is contrast ratio.

FIG. 4: Depicts hysteresis of dye-doped PS-OICLCs having 0.75% by weight, 1.25% by weight, and 1.75% by weight dichroic dye (2). The x-axis is applied voltage (Vᵣₘₛ), and the y-axis is contrast ratio.

FIG. 5: Depicts rise response times (round symbols) and decay response times (square symbols) for dye-doped PS-OICLCs with different dye contents. The x-axis is dye content in wt %, and the y-axis is response time in microseconds.

FIG. 6: Depicts Kerr constants (nm/V²) for dye-doped PS-OICLCs with different dye contents. Testing was carried out at 18° C. and 532 nm. The x-axis is dye content in wt %, and the y-axis is Kerr constant in nm/V².

### DETAILED DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit the scope of the claims.

A first disclosed aspect is a liquid crystal composition that includes at least one dichroic dye. In certain embodiments, the liquid crystal compositions are optically isotropic liquid crystals.

Dichroic dye compounds include, but are not limited to, compounds of formula (1):

Wd-Ad-Zd, (1)
wherein Wd is alkyl, alkoxyl, hydroxyl substituted alkyl, —CN, —NO₂, N-piperidinyl, N-pyrrolidinyl, N-benzathiazolyl, or —NR₁R₂, wherein R₁ and R₂ are independently alkyl, alkoxyl, an alkylidene ring, or hydroxyl substituted alkyl;
Ad is anthraquinolenyl, or

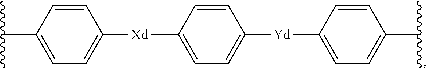

wherein Xd is bond, —C(═O)—, —C(═O)—O—, —O—C(═O), —N═N—, or anthraquinolenyl, and
Yd is bond, —C(═O)—, —C(═O)—O—, —O—C(═O)—, —N═N—, or anthraquinolenyl; and
Zd is alkyl, alkoxyl, hydroxyl substituted alkyl, —CN, —NO₂, N-piperidinyl, N-pyrrolidinyl, N-benzathiazolyl, or —NR₁R₂, wherein R₁ and R₂ are independently alkyl, alkoxyl, an alkylidene ring, or hydroxyl substituted alkyl.

In some embodiments, Xd and Yd are —N═N—. In other embodiments, one of Xd and Yd is —N═N—. In another embodiment, Xd is —N═N—, and Yd is a bond, —C(═O)—, —C(═O)—O—, or —O—C(═O)—. In yet another embodiment, Xd is an anthraquinolenyl, and Yd is a bond, —C(═O)—, —C(═O)—O—, or —O—C(═O)—. In still another embodiment, Xd and Yd are independently —C(═O)—, —C(═O)—O—, or —O—C(═O)—. A non-limiting example of a bis-azo dye has structure (2):

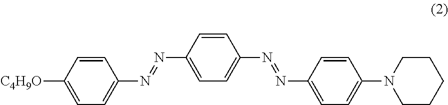

In some embodiments, Xd and Yd are anthraquinolenyl. In other embodiments, one of Xd and Yd are an anthraquinolenyl. The anthraquinolenyl may be independently connected through the 1,5; 1,6; 1,7; 1,8; 2,5; 2,6; 2,7; or 2,8 positions.

In some embodiments, Wd is alkyl, alkoxyl, hydroxyl substituted alkyl, —CN, or —NO₂. In other embodiments, Wd is N-piperidinyl, N-pyrrolidinyl, N-benzathiazolyl, or —NR₁R₂, wherein R₁ and R₂ are independently alkyl, alkoxyl, an alkylidene ring. In various embodiments, Zd is N-piperidinyl, N-pyrrolidinyl, N-benzathiazolyl, or —NR₁R₂, wherein R₁ and R₂ are independently alkyl, alkoxyl, an alkylidene ring. In other embodiments, Zd is alkyl, alkoxyl, hydroxyl substituted alkyl, —CN, or —NO₂.

Liquid crystal compositions may further include at least one nematic liquid crystal compound; and at least one chiral agent in a polymer matrix, wherein the liquid crystal composition exhibits an optically isotropic liquid crystal phase.

In some embodiments, the polymer matrix may be a polyurethane. In such embodiments, the polymer matrix includes at least one urethane monomer unit. In other embodiments, the polymer matrix may be a polyacrylate.

The polymer matrix may include a first monomer unit. In some embodiments, the first monomer unit may be 2-ethylhexyl acrylate, trimethylolpropane triacrylate, phthalate diethylene glycol diacrylate, neopentyl glycol diacrylate, or a combination thereof. In other embodiments, the polymer matrix may include a first monomer unit and at least one second monomer unit different from the first monomer unit. In select embodiments, the first monomer unit may be 2-ethylhexyl acrylate. In select embodiments, the second monomer unit may be trimethylolpropane triacrylate, phthalate diethylene glycol diacrylate, neopentyl glycol diacrylate, or a combination thereof.

The at least one second monomer unit may be a compound of the formula (3):

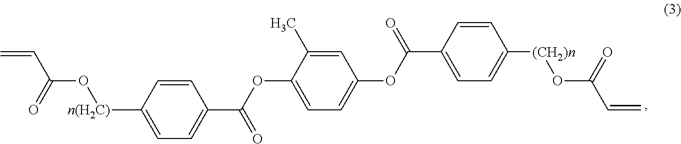

wherein n is 2, 3, 4, 5, or 6. In an embodiment, n is 3 (“PTPTP3”). In another embodiment, n is 6 (“PTPTP6”). In still another embodiment, the at least one second monomer unit includes PTPTP3 and PTPTP6 in about a 1:1 weight ratio. In yet another embodiment, the polymer matrix includes about 20-50% by weight of 2-ethylhexyl acrylate, about 25-40% by weight of PTPTP3, and about 25-40% by weight of PTPTP6. In another embodiment, the 2-ethylhexyl acrylate, PTPTP3, and PTPTP6 are in about a 1:1:1 weight ratio.

In some embodiments, the liquid crystal compositions may be photopolymerizable or thermo-polymerizable. The liquid crystal compositions may include at least one photoinitiator. Photoinitiators are any material that is transformed from an inactive form to an active form upon exposure to light radiation including, but not limited to, visible or ultraviolet radiation. Such photoinitiators can be used to initiate radical polymerization. Photoinitiators may include, but are not limited to, such compounds as in the following formulas:

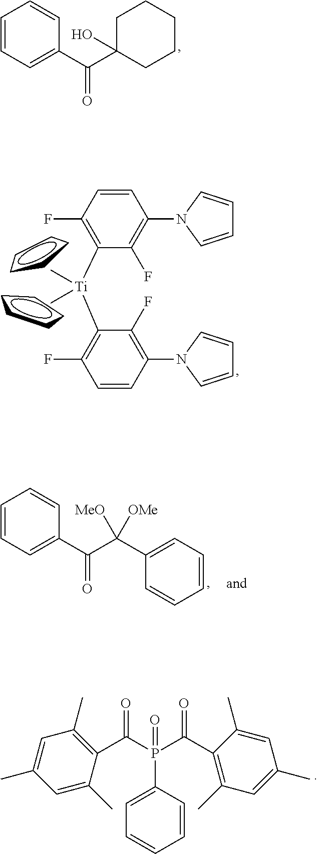

The Irgacure® line of photoinitiators, including those shown above, are known in the art and available from BASF.

The liquid crystal compositions may include without limitation any liquid crystal compound with a nematic phase. Commercially available liquid crystal compounds are known in the art, and include XH-07X, for example from Xianhua Chemical, which contains four kinds of liquid crystal compounds. Other known in the art liquid crystal compounds are the E or BL series from Xianhua Chemical. Still other liquid crystal compounds include those of the formula (4):

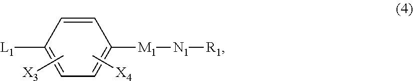

wherein L₁ is alkyl, alkenyl, alkoxyl, —CN, —SCN, —CH₂F, —CHF₂, or —CF₃;
M₁ is a bond, phenylene, —C≡C—, —CH═CH—, —C(O)—O—, —O—C(O)—, —CH═N—, —N═CH—, —N═N—, —N(O)═N—, or —N═N(O)—;
N₁ is a

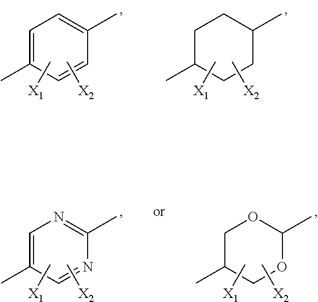

wherein X₁ is hydrogen or fluorine, and
X₂ is hydrogen or fluorine;
R₁ is alkyl, cycloalkyl, alkenyl, alkoxyl, —CN, —SCN, —CH₂F, —CHF₂, —CF₃, alkyl substituted cycloalkyl, or alkyl substituted aryl;
X₃ is hydrogen or fluorine; and
X₄ is hydrogen or fluorine.

In various embodiments, the liquid crystal compound wherein L₁ is —CN;
M₁ is a bond;
N₁ is

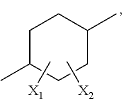

wherein
   X₁ is hydrogen or fluorine, and
   X₂ is hydrogen or fluorine;
X₃ is hydrogen or fluorine;
X₄ is hydrogen or fluorine; and
R₁ is alkyl, alkoxyl, cycloalkyl, alkyl substituted cycloalkyl, or alkyl substituted aryl.

In certain embodiments, an achiral liquid crystal compound can form a chiral nematic liquid crystal when doped with at least one optically active chiral agent. The optically active chiral agent may include, without limitation, any optically active chiral compound. In some embodiments, the optically active chiral agent is enantiomerically enhanced. In other embodiments, the optically active chiral agent is optically pure. Commercially available optically active chiral compounds include compounds known in the art, for example, the following compounds from Merck:

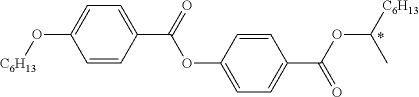

### as R811/S811;

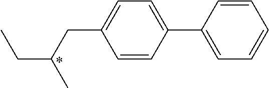 [SMILES: CCC(C)Cc1ccc(-c2ccccc2)cc1]

### as C15/CB15,

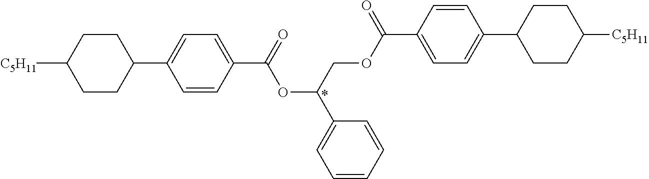

as ZLI-4572/ZLI-4571; S-1082, ZLI-811/ZLI-3786; and MLC-6247/MLC-6248. Commercially available optically active chiral compounds include compounds known in the art, for example, compounds of the CM® series made by Chisso. Other chiral agents include enantiomerically enhanced compounds of the formula (5):

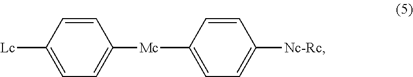

wherein Lc is an alkoxyl;
Mc is a bond, —CH═N—, —C(O)—O—, or —O—C(O)—;
Nc is phenylene, —CH═CH—, —C(O)—O—, or —O—; and
Rc is —CH₂—CH*(CH₃)(CₙH₂ₙ₊₁), wherein n is 2-6, and * indicates a chiral center.

Liquid crystal compositions include those wherein the weight percentage of the dichroic dye is about 0.25% to about 10% relative to a total weight of the liquid crystal composition. In some embodiments, the relative weight percent of dichroic dye is about 0.25%, about 0.5%, about 0.75%, about 1.0%, about 1.25%, about 1.5%, about 1.75%, about 2%, about 5%, about 10%, and ranges between any two of these values including endpoints.

Liquid crystal compositions include those wherein the weight percentage of the chiral agent is about 2% to about 50% relative to a total weight of the liquid crystal composition. In some embodiments, the relative weight percent of chiral agent is about 2%, about 3%, about 4%, about 5%, about 10%, about 15%, about 20%, about 22%, about 23%, about 25%, about 30%, about 50%, and ranges between any two of these values including endpoints.

Liquid crystal compositions include those wherein the polymer matrix is about 1% to about 50% relative to a total weight of the liquid crystal composition. In some embodiments, the relative weight percent of polymer matrix is about 1%, about 2%, about 3%, about 4%, about 5%, about 10%, about 15%, about 20%, about 25%, about 30%, about 40%, about 50%, and ranges between any two of these values including endpoints.

Liquid crystal compositions include those wherein the at least one nematic liquid crystal compound is about 30% to about 97% relative to a total weight of the liquid crystal composition. In some embodiments, the relative weight percent of at least one nematic liquid crystal compound is about 30%, about 40%, about 50%, about 60%, about 65%, about 70%, about 80%, about 90%, about 95%, about 96%, about 97%, and ranges between any two of these values including endpoints.

The liquid crystal compositions may include those wherein the weight percentage of the photoinitiator is about 0.1% to about 2% relative to a total weight of the liquid crystal composition. In some embodiments, the relative weight percent of photoinitiator about 0.1%, about 0.25%, about 0.4%, about 0.5%, about 0.6%, about 0.75%, about 1.0%, about 1.25%, about 1.5%, about 1.75%, about 2%, and ranges between any two of these values including endpoints.

In some embodiments, the liquid crystal compositions may have a contrast ratio of about 2:1 to about 20:1. In other embodiments, the contrast ratio is about 2:1, about 7:1, about 9:1, about 10:1, about 11:1, about 12:1, about 14:1, about 16:1, about 18:1, about 20:1, and ranges between any two of the values including endpoints. In various embodiments, the polymer-liquid crystal composite may have a Kerr constant of about 10 nmV⁻² to about 20 nmV⁻². In other embodiments, the Kerr constant is about 8 nmV⁻², about 10 nmV⁻², about 12 nmV⁻², about 14 nmV⁻², about 16 nmV⁻², about 18 nmV⁻², about 20 nmV⁻², and ranges between any two of the values including endpoints.

The liquid crystal compositions can be polarization-independent electro-optical compositions.

A second aspect is a method of preparing a liquid crystal composition, the method including the steps of combining at least one dichroic dye, at least one chiral agent, at least one nematic liquid crystal compound, and at least one monomer to give a mixture; heating the mixture to give an isotropic phase; and polymerizing the mixture in the isotropic phase. The polymerization may form a cross-linked structure.

The polymerization may be carried out when the mixture is in an isotropic phase. In some embodiments, the mixture further includes at least one photoinitiator. In some embodiments, the polymerizing is thermally initiated. In other embodiments, the polymerizing is initiated by exposure to UV light or other electromagnetic radiation. The exposure to UV light may be for any suitable duration of time, such as about 20 seconds to about 1 hour. In other embodiments, the exposure to UV light may be any suitable intensity, such as at about 3 mW/cm² to about 3 W/cm². In still other embodiments, the exposure to UV light is for about 20 seconds to about 1 hour and at about 3 mW/cm² to about 3 W/cm².

In an embodiment, the weight percent of the liquid crystal composition is 50-99% and the weight percent of the monomer is 1 to 50%. In embodiments, the weight percent of the monomer is about 1%, about 2%, about 5%, about 10%, about 20%, about 30%, about 40%, about 50%, and ranges between any two of these values including endpoints. In various embodiments, the weight percent of the at least one dichroic dye is about 0.25%, about 0.5%, about 0.75%, about 1.75%, about 2%, about 3%, about 5%, about 10%, and ranges between any two of these values including endpoints.

Devices including at least two substrates, at least one electrode disposed on a surface of one or both of the pair of substrates, a liquid crystal composition disposed between the pair of substrates, and an electric field application means for applying an electric field to the liquid crystal composition via the electrodes, wherein the liquid crystal composition comprises at least one dichroic dye compound, are disclosed.

The isotropic phase of such devices can be well maintained at temperatures below 0° C. The electro-optical performances of such devices demonstrate large Kerr constants, fast response times, and large contrast ratios. The power consumption and the cost of devices can be decreased substantially due to alignment-free and polarizer-free characteristics.

In an embodiment, the at least one dichroic dye compound may be represented by formula (1):

Wd-Ad-Zd, (1)
wherein Wd is alkyl, alkoxyl, hydroxyl substituted alkyl, —CN, —NO₂, N-piperidinyl, N-pyrrolidinyl, N-benzathiazolyl, or —NR₁R₂, wherein R₁ and R₂ are independently alkyl, alkoxyl, an alkylidene ring, or hydroxyl substituted alkyl;
Ad is anthraquinolenyl, or

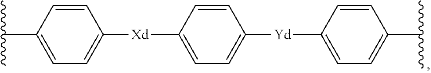

wherein Xd is bond, —C(═O)—, —C(═O)—O—, —O—C(═O)—, —N═N—, or anthraquinolenyl, and
Yd is bond, —C(═O)—, —C(═O)—O—, —O—C(═O)—, —N═N—, or anthraquinolenyl; and
Zd is alkyl, alkoxyl, hydroxyl substituted alkyl, —CN, —NO₂, N-piperidinyl, N-pyrrolidinyl, N-benzathiazolyl, or —NR₁R₂, wherein R₁ and R₂ are independently alkyl, alkoxyl, an alkylidene ring, or hydroxyl substituted alkyl.

In some embodiments, Xd and Yd are —N═N—. In other embodiments, one of Xd and Yd is —N═N—. In another embodiment, Xd is —N═N—, and Yd is a bond, —C(═O)—, —C(═O)—O—, or —O—C(═O)—. In yet another embodiment, Xd is an anthraquinolenyl, and Yd is a bond, —C(═O)—, —C(═O)—O—, or —O—C(═O)—. In still another embodiment, Xd and Yd are independently —C(═O)—, —C(═O)—O—, or —O—C(═O)—. A non-limiting example of a bis-azo dye has structure (2):

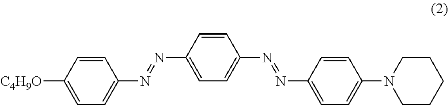

In some embodiments, Xd and Yd are anthraquinolenyl. In other embodiments, one of Xd and Yd are an anthraquinolenyl. The anthraquinolenyl may be independently connected through the 1,5; 1,6; 1,7; 1,8; 2,5; 2,6; 2,7; or 2,8 positions.

In some embodiments, Wd is alkyl, alkoxyl, hydroxyl substituted alkyl, —CN, or —NO₂. In other embodiments, Wd is N-piperidinyl, N-pyrrolidinyl, N-benzathiazolyl, or —NR₁R₂, wherein R₁ and R₂ are independently alkyl, alkoxyl, an alkylidene ring. In various embodiments, Zd is N-piperidinyl, N-pyrrolidinyl, N-benzathiazolyl, or —NR₁R₂, wherein R₁ and R₂ are independently alkyl, alkoxyl, an alkylidene ring. In other embodiments, Zd is alkyl, alkoxyl, hydroxyl substituted alkyl, —CN, or —NO₂.

The liquid crystal composition may further include at least one nematic liquid crystal compound, at least one chiral agent, in a polymer matrix, wherein the liquid crystal composition exhibits an optically isotropic liquid crystal phase. The polymer matrix may include a first monomer unit. In some embodiments, the first monomer unit is 2-ethylhexyl acrylate, trimethylolpropane triacrylate, phthalate diethylene glycol diacrylate, neopentyl glycol diacrylate, or a combination thereof. In other embodiments, the polymer matrix may include a first monomer unit and at least one second monomer unit different from the first monomer unit. In select embodiments, the first monomer unit is 2-ethylhexyl acrylate. In select embodiments, the second monomer unit is trimethylolpropane triacrylate, phthalate diethylene glycol diacrylate, neopentyl glycol diacrylate, or a combination thereof. In some embodiments, the at least one first monomer unit is 2-ethylhexyl acrylate, and the at least one second monomer unit is one or more acrylate monomers represented by the formula (3):

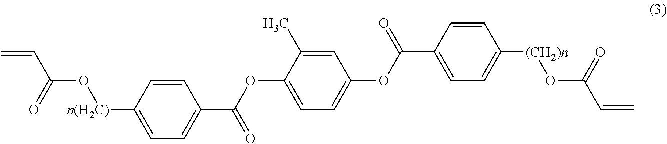

wherein n is 2, 3, 4, 5, or 6. In some embodiments, the liquid crystal composition further includes at least one photoinitiator. Various embodiments of the devices also include, without limitation, liquid crystal compositions using any of the dichroic dyes, initiators, nematic liquid crystal compounds, chiral agents, and polymer matrices in the proportions provided in the description of the first aspect liquid crystal compositions.

In various embodiments, the at least one electrode is a comb electrode. In other embodiments, the at least one electrode is disposed in a matrix form to form pixel electrodes, and each pixel has an active device that is a thin film transistor. In still other embodiments, the at least one electrode is disposed in a matrix form to form pixel electrodes, and each pixel has an active device driven by the electric field and form the active matrix display.

Devices include, but are not limited to, an electronic book reader, a portable game console, a mobile device screen, a computer screen, a television screen, an advertisement screen, a remote control, an information display, an e-signage, a non-flexible display, or a flexible display.

These technologies and embodiments illustrating the method and materials used may be further understood by reference to the following non-limiting examples.

### Example 1

### Preparation of the Dichroic Dye-Doped PS-OICLC Mixtures

A dichroic dye-doped mixture was prepared from an achiral liquid crystal monomer, chiral agent, a dichroic dye, and a monomer. The weight percent of achiral liquid crystal monomer, chiral agent, a dichroic dye to photopolymerizable monomer was 93:7. The chiral nematic liquid crystal, XH-07X (Xianhua Chemical Co., Ltd., China) having an index of refraction of Δn=0.169 at 532 nm, and a clearing point of 62.4° C., was mixed with chiral agent R811 (Merck) in a 3:1 weight ratio. A mixture of acrylate monomers: 2-ethylhexyl acrylate (2-EHA), PTPTP3, and PTPTP6, in a weight ratio of about 1:1:1, was added. Five different aliquots of the mixture were doped dichroic-dye of formula (2) at weight percent concentrations of 0.75%, 1.0%, 1.25%, 1.5%, and 1.75%.

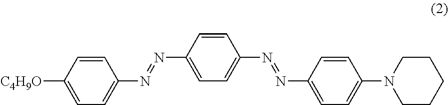

The samples differing in dye concentrations allowed for study of properties that may vary with concentration, such as contrast ratio and response time. To each of the five aliquots was added about 0.5% by weight of the photo-initiator Irgacure 184 (1-hydroxycyclohexyl)-(phenyl)methanone, BASF). The composition of the five aliquots are summarized in Table 1.

TABLE 1
Content (wt %) of five dye-doped optically isotropic
liquid crystals mixtures

| Sample | XH-07X | R811 | 2-EHA | PTPTPₙ | Dye | Photoinitiator |
|---|---|---|---|---|---|---|
| A | 68.06 | 22.69 | 2.67 | 5.33 | 0.75 | 0.5 |
| B | 67.88 | 22.62 | 2.67 | 5.33 | 1.00 | 0.5 |
| C | 67.69 | 22.56 | 2.67 | 5.33 | 1.25 | 0.5 |
| D | 67.50 | 22.50 | 2.67 | 5.33 | 1.50 | 0.5 |
| E | 67.31 | 22.44 | 2.67 | 5.33 | 1.75 | 0.5 |

### Example 2

### Device Using a Dichroic Dye-Doped PS-OICLC

Sample A from Example 1 was stirred at 60° C. The mixture was then injected into a 15-μm-thick cell having planar ITO electrodes on inner surfaces. The temperature was maintained about 65° C. for about one hour. The device using Sample A was prepared by activating the photoinitiator at 365-nanometer lamp using an ultraviolet light with an intensity modulated to about 2.0 mW/cm² for about 40 minutes.

The other devices were prepared using samples B-E of Example 1 in a similar manner.

### Example 3

### Testing Procedures for Dichroic Dye-Doped PS-OICLCs

The temperature range of the isotropic phase materials from Example 2 were evaluated using a controlled cooling rate of about 0.5° C./minute. The optical and electrically tunable properties of samples were tested by an optical-fiber-connected microscope. Samples placed on a microscope stage were tested at room temperature (about 18° C.). The backlight of the microscope was used as a white-light source. The light transmitted through the sample impinged on a dual-channel fiber adaptor. The adaptor split the incidence light into two beams, one of the beams was received by a spectroscope for spectral analysis, and the other beam was received by an oscilloscope-connected photoelectric converter for response time analysis. A 1 kHz voltage-signal was applied through the signal generator in order to test electrical performance. The property of polarization-independency was tested by setting a polarizer on the holder and rotating it to change the polarization direction of the incidence light.

### Example 4

### Temperature Range of a Dichroic Dye-Doped PS-OICLCs

Properties of dichroic-dye were tested by slow heating. Dichroic dye (2) has a crystalline phase at a temperature below about 249° C. Between 249° C. and about 273° C., the crystal changes to a fluid nematic phase with thread-like disclination lines. The nematic phase changes to an isotropic phase at the clearing point, 273° C.

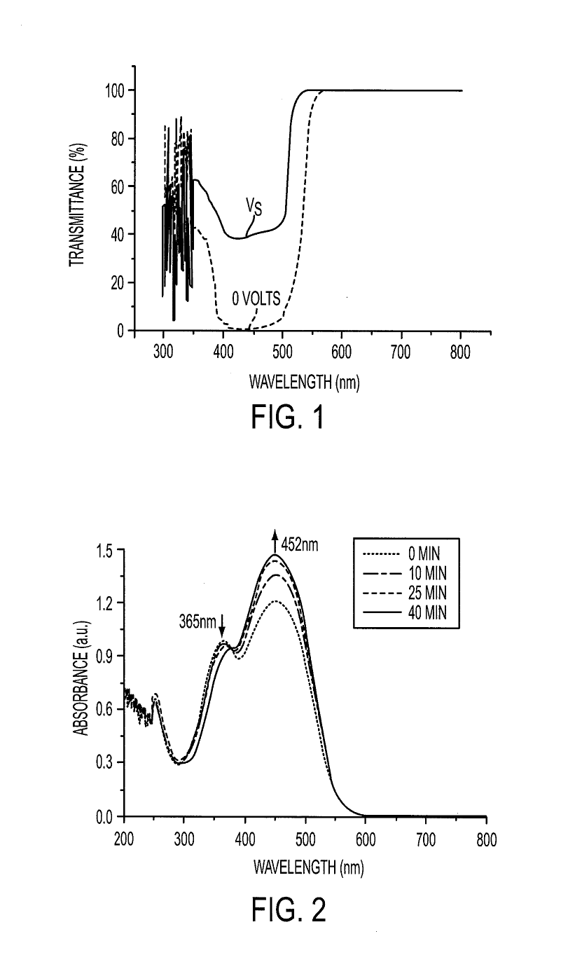

A small amount of dichroic dye (2) (about 1.75 wt %) was doped into a nematic liquid crystal and injected into a parallel aligned cell to form a homogeneous orientation. The transmission spectral characteristics were tested as described in Example 3. As shown in FIG. 1, an evident absorption band of the chromophore, ranging from 400˜500 nm, was observed. As a voltage was applied to the cell, the absorbance decreased gradually due to reorientation of dichroic-dye molecules with the rotation of liquid crystals in the electric field. FIG. 1 shows that as the voltage becomes reaches the saturation voltage, the transmittance increased from about 2.2-2.5% to about 42-45%.

Thus, a substantial difference can be achieved for transmittance over a broad wavelength range between a zero voltage state and a saturated voltage state using dichroic dye-doped PS-OICLCs. The dichroic dye-doped PS-OICLCs were polarization-independent.

### Example 5

### Determining the Absorption Coefficients of Dichroic Dye (2)

Combined with the transmission spectrum shown in FIG. 1, the light intensity may be calculated as the integral area of the spectrum from 400 to 500 nm; c and/can be substituted directly in Eq. (2). At the OFF state (the 0 V spectrum in FIG. 1), the dye-molecules align with the liquid crystals, so the absorption coefficient is α_{∥}; at the saturation voltage (the Vs spectrum in FIG. 1), the dye-molecules are aligned vertically with the substrate of the cell, and the absorption coefficient is α_{⊥}. Thus, the calculated absorption coefficients are α_{∥}=34.4 μm⁻¹, α_{⊥}=9.1 μm⁻¹, and the dichroism of the dye is Δα=25.3 μm⁻¹. The UV-Visible absorption spectrum of the dichroic dye (2) was determined, and two main peaks at 365 and 452 nm were observed as shown in FIG. 2, corresponding to the diazo isomerization of trans-to-cis and cis-to-trans.

The peak at 365 nm drops while the other peak at 452 nm rises with the extension of exposure time. As shown in FIG. 2, the changes are small relative to total absorbance, which indicates UV exposure on polymerization has little effect on dye isomerization.

### Example 6

### Contrast Ratios of Dichroic Dye-Doped PS-OICLC

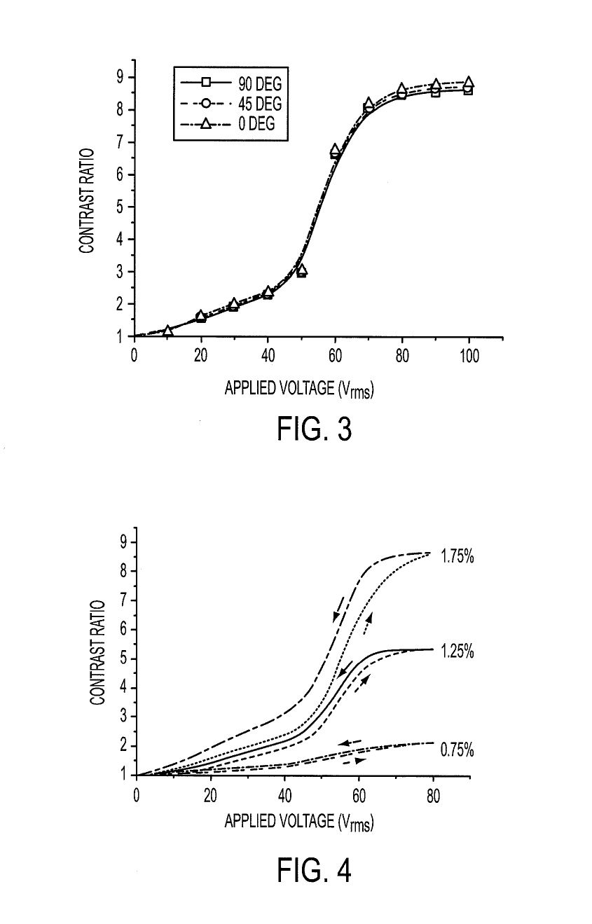

The voltage dependent contrast ratios the devices of Example 2 were tested to study electro-optical performance and to compare changes on electro-optical behavior caused by the concentration of dichroic dye (2). Contrast ratios were determined as an integral of the area of the transmission spectral band range from 400 to 500 nm as a ratio comparing voltage on and off states. The backlight of microscope was used as the unpolarized source. As shown in FIG. 3, contrast ratio increased with increased applied voltage and the contrast ratio saturated as the voltage reaches about 70 Vᵣₘₛ because of the rotation of the dyes with the liquid crystals. The saturation contrast ratio rose with an increase of dye concentration. As the concentration increased from 0.75% to 1.75% by weight, the contrast ratio rose from 2.2 to 8.9. As the content of dichroic dye exceeded about 2% by weight, there was no significant rise in the contrast ratio, possibly due to the undissolved red-particles observable by microscope.

Thus, high contrast ratios may be obtained by dichroic dye-doped PS-OICLCs, with higher dye levels leading to higher contrast ratios.

### Example 7

### Hysteresis of a Dichroic Dye Doped PS-OICLC

FIG. 4 shows the hysteresis behavior for the five samples prepared in Example 2. Hysteresis increased with increased dye concentration. Such results may relate to an increased interaction between dichroic-dye molecules, which led to longer orientation times required for the liquid crystal to reorient the dichroic dye with the electric field.

The polymer-stabilized liquid crystal materials exhibited hysteresis. Large hysteresis may lead to problems during electric modulation. Minimizing hysteresis is a desirable feature. Dichroic dye doped PS-OICLCs demonstrate minimal hysteresis at low dye concentrations, allowing fast rise and decay times.

### Example 8

### Response Time of a Dichroic Dye Doped PS-OICLC

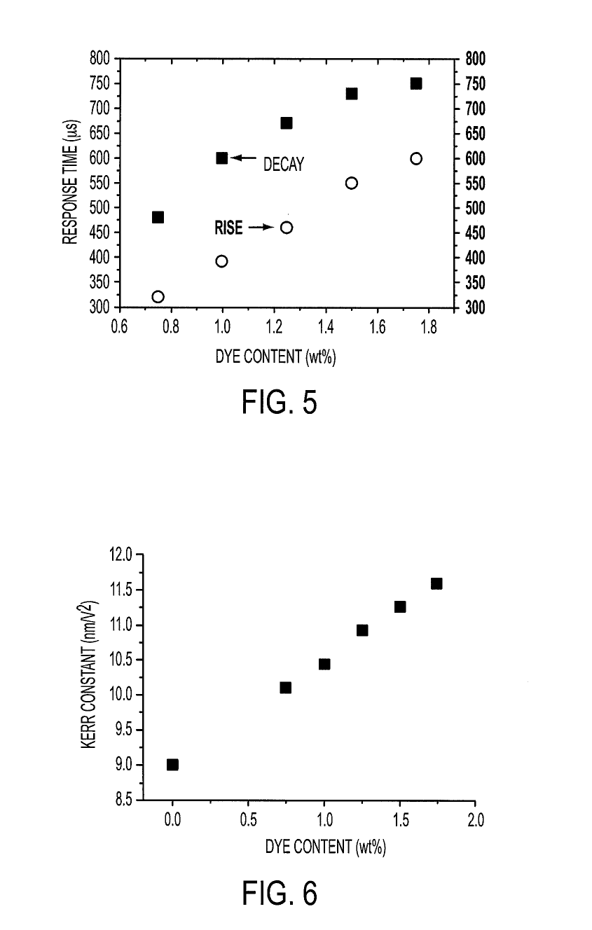

The response time of the devices of Example 2 were tested at about 20° C. by applying a voltage of 80 volts. The rise and decay response times are shown in FIG. 5 for various dye concentrations. The results indicate an increased concentration accompanies extended rise and decay times. With a concentration of 0.75% by weight of dichroic dye (2), the rise and decay response times were 324 and 480 microseconds, respectively. Samples having 1.75 weigh % of dichroic dye (2) had a rise and decay response time of 600 and 750 microseconds, respectively.

The visco-elastic coefficient (γ/K) of the system increased linearly with the increasing of dye content. Thus, response times and decay times were found to be nearly linearly dependent on the dichroic dye concentration. Lower concentration of dye leads to quicker response times.

### Example 9

### Kerr Constant of a Dichroic Dye Doped PS-OICLC

The Kerr effect reflects the electro-optical behavior of the device. The Kerr constant of the samples of Example 2 were tested by the methodology as described in Example 3. FIG. 6 shows the Kerr constant linearly increases from about 10.1 nmV⁻² (about 0.75% by weight dichroic dye (2)) to about 11.6 nmV⁻² (about 1.75% by weight dichroic dye (2)). The large Kerr constants may be ascribed to an easy reorientation of chiral liquid crystal domains under the electric field. The polymer network may have suppressed the electric-field-induced phase transition from isotropy to liquid crystal phase.

Thus, the dichroic dye doped PS-OICLCs have excellent properties for display technology, such as polarization-independence, sub-millisecond response time and the high Kerr constant leading to low power consumption.

### Example 10

### Device Having a Dichroic Dye Doped PS-OICLC

An optical display comprises a layer of dichroic dye doped PS-OICLC material enclosed between opposed carrier plates. A liquid crystal material (dichroic dye doped PS-OICLC) is interposed between a pair of substrates constructed of glass or a suitable polymer. The inner surfaces of the substrates are coated with a transparent conducting film of indium tin oxide. Spacers, which may be polymeric films or glass beads, define the cell thickness between the carrier plates. The distance between the substrates is about 3 microns. The periphery of the substrates are provided with a seal for avoiding loss of the liquid crystal material. An electrode is disposed in a matrix form to form pixel electrodes. Each pixel may be driven by an electric field to form an active matrix display.

The display is assembled into electronic tags, books, billboard, or optical filter and other photonic devices. The application of these materials in a broad range of displays may save 50% or more power consumption, due to its polarization-independent and fast response time.

It must be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

The term “alkyl” or “alkyl group” refers to a branched or unbranched hydrocarbon or group of 1 to 16 carbon atoms, such as but not limited to methyl, ethyl, n-propyl, n-butyl, n-hexyl, n-octyl, n-decyl, n-dodecyl, n-tetradecyl, n-hexadecyl, isopropyl, isobutyl, t-butyl, and the like. The term “alkenyl” or “alkenyl group” refers to a branched or unbranched hydrocarbon or group of 1 to 16 carbon atoms, having one or more unsaturations, such as but not limited to ethenyl, propenyl, butenyl, butadienyl, isobutylenyl, and the like. “Cycloalkyl” or “cycloalkyl groups” are branched or unbranched hydrocarbons in which all or some of the carbons are arranged in a ring, such as but not limited to cyclopentyl, cyclohexyl, methylcyclohexyl and the like. The term “alkoxy” refers to an O-alkyl. Alkyl, alkenyl, cycloalkyl, and alkoxy groups may be substituted with one or more hydroxyl groups or one or more halogen atoms.

The term “aryl” or “aryl group” refers to aromatic hydrocarbon radicals or groups consisting of one or more fused rings in which at least one ring is aromatic in nature. Aryls may include but are not limited to phenyl, napthyl, biphenyl ring systems and the like. “Phenylene” refers to an aryl that is a phenyl having two points of attachment. “Anthraquinolenyl” is an aryl that is anthraquinone having two or more points of attachment. The two points of attachment may at the 1,5; 1,6; 1,7; 1,8; 2,5; 2,6; 2,7; or 2,8 positions. Some anthraquinolenyl dyes have four points of attachment at the 1, 4, 5, and 8 positions. In select embodiments, an anthraquinolenyl is connected through the 1,5 positions.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various compositions and methods are described in terms of “comprising” various components or steps (interpreted as meaning “including, but not limited to”), the compositions and methods can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (such as, bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (such as, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (such as, the bare recitation of “two recitations,” without other modifiers, means at least two recitations, or two or more recitations). Furthermore, in those instances where a convention analogous to “at least one of A, B, and C, and the like” is used, in general such a construction is intended in the sense one having skill in the art would understand the convention (such as, “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (such as, “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or embodiments of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third and upper third, and the like. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “chiral” means existing as a pair of enantiomers. The enantiomers or stereoisomers, are designated the R and S isomers, and are nonsuperimposable mirror images of one another. A chiral material may either contain an equal amount of the R and S isomers in which case it is called racemic or it may contain inequivalent amounts of R and S isomer in which case it is called “optically active,” or nonracemic.

“Enantiomeric excess” means the absolute difference between the percent of R enantiomer and the percent of S enantiomer of an optically active compound. For example, a compound which contains 75% S isomer and 25% R isomer will have an enantiomeric excess of the S-isomer of 50%. As used herein the term “enantiomerically enhanced” refers to an enantiomeric excess greater than 80%. As used herein the term “optically pure” refers to an enantiomeric excess greater than 98%.

As used herein, “contrast ratio” is a ratio of the light transmittance of a material in the dark state and the light state. For example, a material may allow transmission of about 10% of the visible light (10% VLT) in a dark state, and about 60% of the visible light (60% VLT) in a faded state, providing a contrast ratio of 6:1.

The Kerr constant (K) of the optical isotropic material can be measured using following theoretical expression,

Δn=λKE² (1)

The birefringence (Δn) of a sample is proportional to the square of electric field (E), when the wavelength (λ) of light source is constant. K may be obtained by calculating the slope of the line (Δn˜E²). Because in-plane switching drive always leads to non-uniform distribution of electric field in a cell, the uniform electric field, generated between two planar electrodes, was adopted for the testing. During testing, the beam may be varied at different incidence angles on the cell (the incidence angle is defined as θ), thus the change of Δn under the applied field can be measured. The Δn−E² curve at a certain incidence angle (θ) can be obtained, and an extended Kerr equation was used to fit this curve; therefore the incidence angle related Kerr constant, K_{θ}, was calculated. An equation of θ versus K can be fitted through θ˜K datum. As the term θ=90° is substituted into the equation, the Kerr constant can be obtained independent of the distribution of the electric field.

Absorption coefficients (α_{∥} and α_{⊥}) and the dichroism (Δα=α_{∥}−α_{⊥}) of a dichroic dye can be calculated through Beer's law, in which, I₀ and I_{T} represent the intensity

I_{T}=I₀e^{-cαl} (2)

before and after the light is transmitted through the sample; c and α are the content and the absorption coefficient of the dichroic-dye respectively; and l is the cell-gap.

The response time of a sample may be expressed as equation 4 wherein the pitch

$$τ = \frac{γ}{K} \frac{{P}^{2}}{{( 2 π )}^{2}} \qquad ( 4 )$$

of the system is independent of the dye content, thus the response time (τ) may be determined by γ/K, and shows a similar linear tendency.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid crystal composition, comprising
about 30% to about 97% by weight of a nematic liquid crystal compound;
about 2% to about 50% by weight of a chiral agent; and
about 0.25% to about 10% by weight of a dichroic dye compound of formula (1):
Wd-Ad-Zd, (1)
wherein
the nematic liquid crystal compound, chiral agent, and dichroic dye compound are in a polymer matrix, where the polymer matrix is about 1% to about 50% by weight of the composition;
Wd is alkyl, alkoxyl, hydroxyl substituted alkyl, —CN, —NO₂, N-piperidinyl, N-pyrrolidinyl, N-benzathiazolyl, or —NR₁R₂, wherein R₁ and R₂ are independently alkyl, alkoxyl, an alkylidene ring, or hydroxyl substituted alkyl;
Ad is 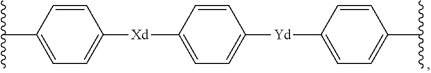
wherein Xd is bond, —C(═O)—, —C(═O)—O—, —O—C(═O)—, —N═N—, or anthraquinolenyl; and Yd is bond, —C(═O)—, —C(═O)—O—, —O—C(═O)—, —N═N—, or anthraquinolenyl; and
Zd is alkyl, alkoxyl, hydroxyl substituted alkyl, —CN, —NO₂, N-piperidinyl, N-pyrrolidinyl, N-benzathiazolyl, or NR₁R₂, wherein R₁ and R₂ are independently alkyl, alkoxyl, an alkylidene ring, or hydroxyl substituted alkyl.

2. (canceled)

3. The liquid crystal composition of claim 1, wherein the dichroic dye compound is represented by the formula (2):

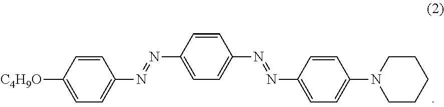

4.-6. (canceled)

7. The liquid crystal composition of claim 1, wherein the polymer matrix comprises
at least one first monomer unit that is 2-ethylhexyl acrylate, and
at least one second monomer unit comprises one or more acrylate monomers represented by the formula (3), 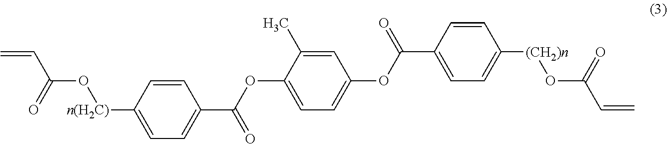
wherein n is 2, 3, 4, 5, or 6.

8. The liquid crystal composition of claim 7, wherein the at least one second monomer unit has n is 3, and further comprising a third monomer unit of formula (3) having n is 6, and the second monomer unit and third monomer unit are in about a 1:1 weight ratio.

9. The liquid crystal composition of claim 1, wherein the at least one first monomer unit comprises 2-ethylhexyl acrylate, and at least one second monomer unit comprises trimethylolpropane triacrylate, phthalate diethylene glycol diacrylate, neopentyl glycol diacrylate, or combination thereof.

10. The liquid crystal composition of claim 8, wherein the polymer matrix comprises an about 1:1:1 weight ratio of compounds of 2-ethylhexyl acrylate, the second monomer unit, and the third monomer unit.

11. The liquid crystal composition of claim 8, wherein the polymer matrix comprises about 20-50% by weight of 2-ethylhexyl acrylate, about 25-40% by weight of the second monomer unit, and about 25-40% by weight of the third monomer unit.

12.-16. (canceled)

17. The liquid crystal composition of claim 1, wherein the nematic liquid crystal compound is of the formula (4): 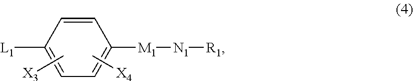
wherein L₁ is alkyl, alkenyl, alkoxyl, —CN, —SCN, —CH₂F, —CHF₂, or —CF₃;
M₁ is a bond, phenylene, —C≡C—, —CH═CH—, —C(O)—O—, —O—C(O)—, —CH═N—, —N═CH—, —N═N—, —N(O)═N—, or —N═N(O)—;
N₁ is a 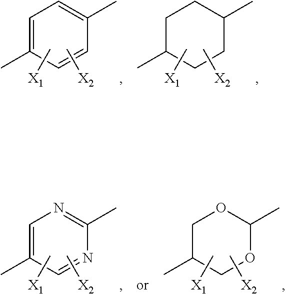
wherein X₁ is hydrogen or fluorine, and
X₂ is hydrogen or fluorine;
R₁ is alkyl, cycloalkyl, alkenyl, alkoxyl, —CN, —SCN, —CH₂F, —CHF₂, —CF₃, alkyl substituted cycloalkyl, or alkyl substituted aryl;
X₃ is hydrogen or fluorine; and
X₄ is hydrogen or fluorine.

18. The liquid crystal composition of claim 17, wherein X₁, X₂, X₃, and X₄ are hydrogen.

19. The liquid crystal composition of claim 17, wherein
L₁ is —CN;
M₁ is a bond;
N₁ is 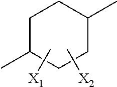
X₁ is hydrogen or fluorine;
X₂ is hydrogen or fluorine;
X₃ is hydrogen or fluorine;
X₄ is hydrogen or fluorine; and
R₁ alkyl, alkoxyl, cycloalkyl, alkyl substituted cycloalkyl, or alkyl substituted aryl.

20. The liquid crystal composition of claim 19, wherein X₁, X₂, X₃, and X₄ are hydrogen.

21. The liquid crystal composition of claim 1, wherein the chiral agent comprises one or more of the following compounds, each of which is enantiomerically enhanced: 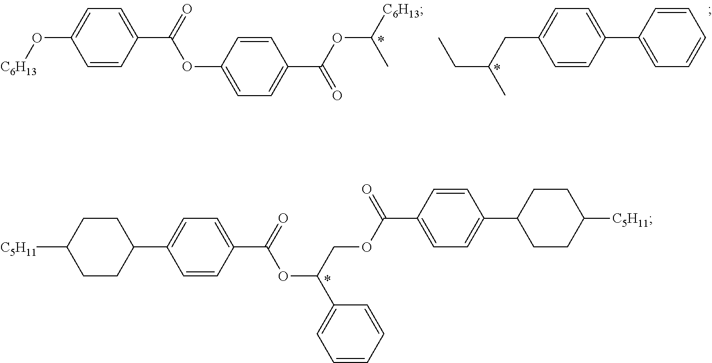
and compounds of formula (5): 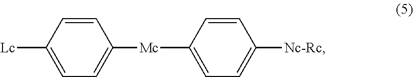
wherein
Lc is an alkoxyl;
Mc is a bond, —CH═N—, —C(O)—O—, or —O—C(O)—;
Nc is phenylene, —CH═CH—, —C(O)—O—, or —O—; and
Rc is —CH₂—CH*(CH₃)(CₙH₂ₙ₊₁), wherein n is 2-6.

22. (canceled)

23. The liquid crystal composition of claim 1, wherein the dichroic dye is present in the liquid crystal composition in an amount of about 0.5% to about 5% by weight.

24. The liquid crystal composition of claim 1, wherein the dichroic dye is present in the liquid crystal composition in an amount of about 0.75% to about 1.75% by weight.

25.-36. (canceled)

37. The liquid crystal composition of claim 1, wherein the at least one nematic liquid crystal compound and the chiral agent are present in the liquid crystal composition in a weight ratio of about 3:1.

38. The liquid crystal composition of claim 7, wherein the 2-ethylhexyl acrylate and the acrylate monomer represented by formula (3) are present in the liquid crystal composition in a weight ratio of about 1:2.

39.-43. (canceled)

44. A method of preparing a liquid crystal composition of claim 1, the method comprising:
combining the dichroic dye, the chiral agent, the nematic liquid crystal compound, and at least one monomer to give a mixture;
heating the mixture to give an isotropic phase; and
polymerizing the mixture in the isotropic phase.

45. The method of claim 44, wherein
the combining further comprises at least one photoinitiator; and
polymerizing is initiated by ultraviolet light exposure of the mixture in the isotropic phase.

46. (canceled)

47. The method of claim 45, wherein polymerizing is initiated by exposing the mixture in the isotropic phase to ultraviolet light for about 20 seconds to about 1 hour.

48-49. (canceled)

50. The method of claim 44, further comprising introducing the mixture between at least a pair of substrates prior to polymerizing.

51.-67. (canceled)
